(19) United States
(12) Patent Application Publication
(10) Pub. No.: US 2024/0046012 A1
(43) Pub. Date: Feb. 8, 2024

(54) SYSTEMS AND METHODS FOR ADVANCED SYNTHETIC DATA TRAINING AND GENERATION

(71) Applicant: MATERCARD ASIA/PACIFIC PTE. LTD., SINGAPORE (SG)

(72) Inventors: Idaly Ali, Singapore (SG); Louis Wong, Singapore (SG); Apurva Vardhan, Singapore (SG); Rui Qin Ng, Singapore (SG); Jonas Ku, Singapore (SG); Bharathi R, Chennai (IN); Hui Chiang Tay, Singapore (SG)

(21) Appl. No.: 17/882,149

(22) Filed: Aug. 5, 2022

(51) Int. Cl. G06F 30/27; G06F 9/54

(52) U.S. Cl. CPC G06F 30/27; G06F 9/543

(57) ABSTRACT

A data generation system for a secure synthetic data generation is provided. The system includes at least one processor and a memory device in operable communication with the at least one processor. The memory device includes computer-executable instructions stored therein, which, when executed by the processor, cause the at least one processor to receive a plurality of historical data including one or more trends; train a data generator with the plurality of historical data and a plurality of noise data to generate data to simulate the one or more trends; receive one or more user input parameters; execute the data generator with the one or more user input parameters to generate a plurality of synthetic data, wherein the plurality of synthetic data includes the one or more trends; and output the plurality of synthetic data to a user.

### BACKGROUND

The field of the invention relates generally to generating synthetic data, and more specifically, to systems and methods for using Generative Adversarial Networks (GAN) to generate synthetic data that mimics original data.

Customer privacy is a significant concern when it comes to customer data. Organizations that collect customer data must navigate an ever growing collection of data storage and data security laws in different jurisdictions. Therefore, the customer data is carefully protected, especially if it contains sensitive information, such as personally identifiable information (PII).

Many organizations want to use data analysis and modelling techniques to analyze their stored data. However, the protections on that data may require a long and tedious process to access the data. Also, only a limited few in the organization may be allowed to access the data. This can cause significant delays in projects and an unfamiliarity of data understanding throughout the organization. Furthermore, these protections limit access to the information only to those in the organization, behind the protections of the organization's network.

In many cases, PII may be stored in hashed datasets. However, hashed datasets can be traced back to individuals using machine learning techniques, despite many of the anonymization techniques that are used. Research has shown with hashed datasets that with just 15 characteristics or parameters, individuals can be traced back with over 95% accuracy. Therefore, in many cases, merely hashing data is not enough in today's world to protect the data.

Accordingly, it would be desirable to have a way to model the customer data for data analysis, while still protecting the customer data and the PII.

### BRIEF DESCRIPTION

In one embodiment, a data generation system for a secure synthetic data generation is provided. The system includes at least one processor and a memory device in operable communication with the at least one processor. The memory device includes computer-executable instructions stored therein, which, when executed by the processor, cause the at least one processor to receive a plurality of historical data including one or more trends. The instruction also causes the at least one processor to train a data generator with the plurality of historical data and a plurality of noise data to generate data to simulate the one or more trends. The instruction further causes the at least one processor to receive one or more user input parameters. In addition, the instruction further causes the at least one processor to execute the data generator with the one or more user input parameters to generate a plurality of synthetic data. The plurality of synthetic data includes the one or more trends. Furthermore, the instruction further causes the at least one processor to output the plurality of synthetic data to a user.

In another embodiment, a method for secure synthetic data generation is provided. The method is implemented by a computer device including at least one processor in communication with at least one memory device. The method includes receiving a plurality of historical data including one or more trends. The method also includes training a data generator with the plurality of historical data and a plurality of noise data to generate data to simulate the one or more trends. The method further includes receiving one or more user input parameters. In addition, the method includes executing the data generator with the one or more user input parameters to generate a plurality of synthetic data, wherein the plurality of synthetic data includes the one or more trends. Furthermore, the method includes outputting the plurality of synthetic data to a user.

### BRIEF DESCRIPTION OF THE DRAWINGS

These and other features, aspects, and advantages of the present disclosure will become better understood when the following detailed description is read with reference to the following accompanying drawings, in which like characters represent like parts throughout the drawings.

FIG. 1 illustrates a first system architecture for secured cross-collaboration with third-party data sources, in accordance with at least one embodiment.

FIG. 2 illustrates a synthetic data generator for training synthetic data, in accordance with at least one embodiment.

FIG. 3 illustrates a system for secured cross-collaboration using the synthetic data generator shown in FIG. 2.

FIG. 4 illustrates a second system architecture for secured cross-collaboration using the synthetic data generator shown in FIG. 2 and the system shown in FIG. 3.

FIG. 5 illustrates an example data flow for secured cross-collaboration using the synthetic data generator shown in FIG. 2 via an application programming interface (API)

FIG. 6 illustrates an example configuration of a client system shown in FIG. 1, in accordance with one embodiment of the present disclosure.

FIG. 7 illustrates an example configuration of a server system that may be used to implement one or more computer devices shown in FIG. 3, in accordance with one embodiment of the present disclosure.

FIG. 8 illustrates an example process for pre-processing data to remove bias in accordance with at least one embodiment of the present disclosure.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system. The above examples are not intended to limit in any way the definition and/or meaning of the term database. Examples of RDBMS's include, but are not limited to, Oracle® Database, My SQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

A computer program of one embodiment is embodied on a computer-readable medium. In an example, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, servers, and respective processing elements thereof.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

The field of the disclosure relates generally to generating synthetic data, and more specifically, to systems and methods for using Generative Adversarial Networks (GAN) to generate synthetic data that mimics original data. This disclosure provides a mechanism to generate synthetic data that mimics the distribution of the original data to provide data for analysis and testing while protecting the privacy of those whose data is contained in the original data.

This disclosure provides a synthetic data generator that receives a data set and trains a model to generate anonymized data to mimic the distribution of the original data set, without being tied to individual records. The anonymized data is protected from being backwards traceable to any individual. The synthetic data generator can be used to dynamically create synthetic data, so that it can provide updated information when the original data set changes.

Generative Adversarial Networks (GAN) are an approach to generative modeling using deep learning methods, such as convolutional neural networks. Generative modeling is an unsupervised learning task in machine learning that involves automatically discovering and learning the regularities or patterns in input data in such a way that the model can be used to generate or output new examples that plausibly could have been drawn from the original dataset. GANs train a generative model by framing the problem as a supervised learning problem with two sub-models: the generator model that is trained to generate new examples, and the discriminator model that tries to classify examples as either real (from the domain) or fake (generated). The two models are trained together in a zero-sum game, adversarial, until the discriminator model is fooled about half the time, meaning the generator model is generating plausible examples.

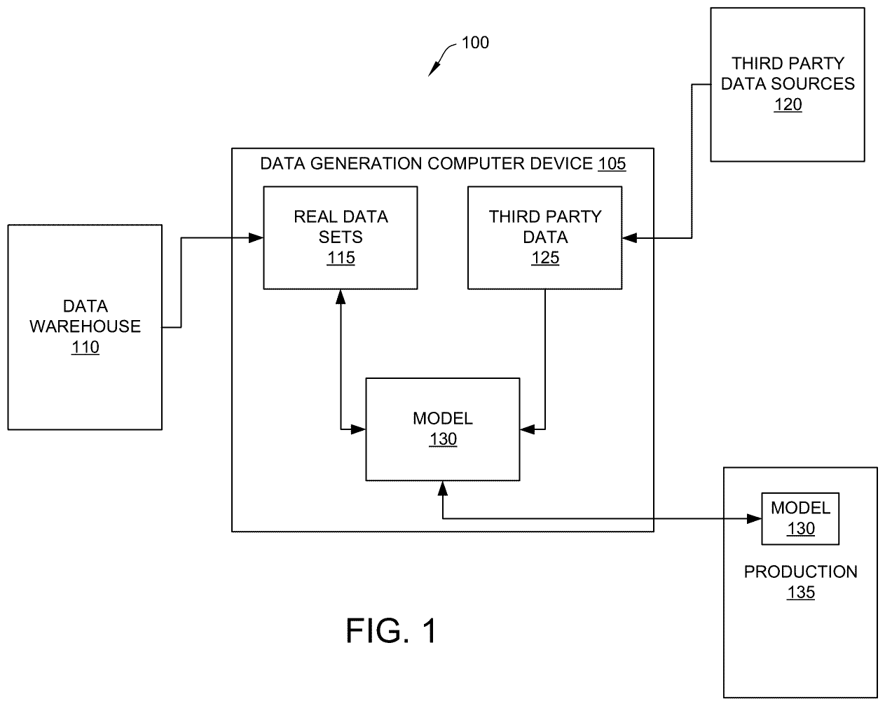

FIG. 1 illustrates a first system 100 for secured cross-collaboration with third-party data sources, in accordance with at least one embodiment of the present disclosure. The system 100 includes a data generation computer device 105. The data generation computer device 105 is in communication with a data warehouse 110. The data warehouse 110 provides one or more real data sets 115. These real data sets 115 may contain PII, either hashed or anonymized using different techniques. In at least one embodiment, the real data sets 115 can contain hundreds, thousands, or even millions of records. These records may each include a plurality of fields. In at least one embodiment, the real data sets 115 could be transaction data, such as from an individual merchant or from a plurality of merchants. The real data sets 115 may include data from a plurality of locations, such as a plurality of cities, or just from a single city or geographic area.

The data generation computer device 105 is also in communication with one or more third-party data sources 120. The third-party data sources 120 provide third-party data 125 to the data generation computer device 105. The data generation computer device 105 uses the one or more real data sets 115 and the third-party data 125 to build one or more models 130. The models 130 simulate the real data sets 115 by integrating the third-party data 125. The data generation computer device 105 provides the models 130 to production 135. Production 135 may include, but is not limited to, websites, applications, programs, and/or computer devices that will use the model data 130 for data analysis purposes. The system 100 provides one way support for cross-collaboration with third-party data sources 120.

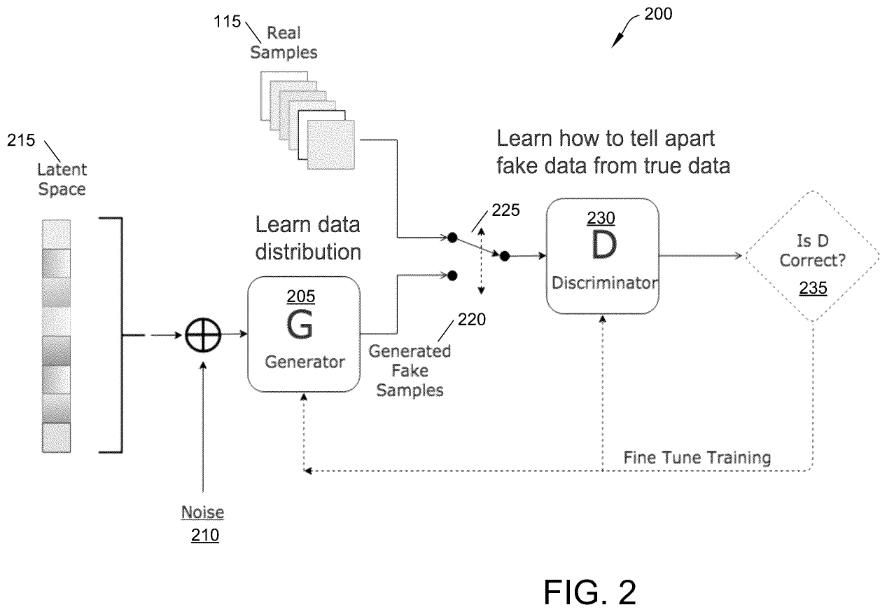

FIG. 2 illustrates a system 200 for training a synthetic data generator 205 for generating synthetic data, in accordance with at least one embodiment of the present disclosure. In system 200, the synthetic data generator 205 is fed noise data 210 and latent space data 215. The noise data 210 is random data while the latent space data 215 is a representation of compressed data. In some embodiments, the noise data 210 is white noise, where the sequence of random data cannot be predicted, where the variables are independent and identically distributed with a mean of zero. Accordingly, each variable has the same variance, and each value has zero correlation with other values. In some further embodiments, the white noise is generated from a Gaussian distribution. The compressed data represents the structural similarities in real data that may be compressed. The generator 205 uses the noise data 210 and the latent space data 215 to generate fake samples 220 of the real data 115. A randomizer 225 decides whether to send a generated fake sample 220 or real data 115 to a discriminator 230. The discriminator 230 is programmed, for example via a machine learning algorithm, to identify whether the data it received is real data 115 or a generated fake sample 220.

The discriminator's results are then analyzed by a results analyzer 235 to determine if the discriminator 230 was correct that the data that is received was a generated fake sample 220 or real data 115. If the data was a generated fake sample 220 or a piece of real data 115, and the discriminator 230 correctly labeled the data, then the results analyzer 235 informs the generator 205. The generator 205 then configures itself and adjusts its output to improve the generated fake data 220 output to appear more like the real data 115. If the data was a generated fake sample 220 and the discriminator 230 thought that the data was real, then the results analyzer 235 informs the generator 205 and provides positive reinforcement. If the data was real data 115 and the discriminator 230 was incorrect, then the results analyzer 235 informs the discriminator 230 of the error, and the discriminator 230 then configures itself and adjusts its output to improve its ability to discriminate between fake samples 220 and real data 115.

The system 100 is executed until the generator 205 consistently provides fake data samples 220 that the discriminator 230 cannot differentiate from the real data 115. Depending on the purpose of training, the system 100 may only be executed until the fake data samples 220 are mis-classified by the discriminator 230 a percentage of the time, such as, 50% of the time, for example consistent with random guessing. At this point, the generator 205 is generating fake data samples 220 that are practically indistinguishable from the real data 115, and thus the generator 205 can be used to generate synthetic data that can mimic the real data 115. For example, trends present in the fields of the real data 115 may be defined by marginal and conditional distributions of the real data 115, and the trained generator 205 outputs synthetic data that includes the same marginal and conditional distributions as the real data 115. The synthetic data can then be used for data analysis to detect trends in similar ways that the real data 115 could have been used, while avoiding the potential privacy issues associated with the use of real data 115, because the synthetic data cannot be traced to any actual individuals.

The generator 205 can be used with a variation of system 100 (shown in FIG. 1).

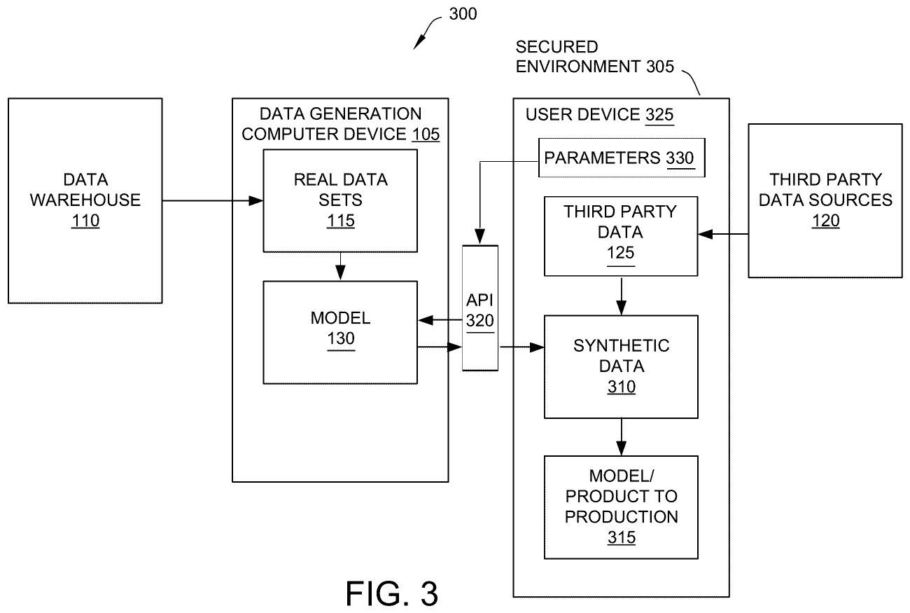

FIG. 3 illustrates a system architecture 300 for secured cross-collaboration using the synthetic data generator 205 (shown in FIG. 2). System architecture 300 is an upgrade of the system 100 (shown in FIG. 1) to allow for a secured environment for third-party data collaboration.

In system architecture 300, the data generation computer device 105 receives the real data 115 from the data warehouse 110. The data generation computer device 105 applies the real data 115 to the synthetic data generator 205. The synthetic data generator 205 is trained by system 200 using the real data 115 to generate synthetic data that mimics the real data 115.

The data generation computer device 105 is in communication with a secured environment 305. The secured environment 305 may be, but is not limited to, a computer device, a plurality of computer devices, a computer network, an application, and/or any combination thereof. The user is associated with the secured environment 305. In some embodiments, the user connects to the secured environment via a user device 325. In some embodiments, system 300 includes an interface 320 that enables the user, e.g., via user device 325, to request, specify parameters 330 for, and receive synthetic data 310. In the illustrated embodiment, interface 320 is implemented as an Application Programming Interface (API) configured to receive requests for synthetic data and return the synthetic data 310 to the requestor. Alternatively, interface 320 is implemented in any suitable fashion. In some embodiments, interface 300 is implemented on a server computing device remote from, and in networked communication with, data generation computer device 105. In other embodiments, interface 320 is implemented on or locally with data generation computer device 105.

The secured environment 305 receives the third-party data 125 from the third-party data sources 120. The secured environment 305 interfaces with the synthetic data generator 205 of the data generation computer device 105, for example using a call to API 320. In some embodiments, the secured environment 305 receives one or more parameters 330 for the API call from the user via the user device 325. The synthetic data generator 205 provides synthetic data 310 in response to the API call. The secured environment 305 uses the third-party data 125 and the synthetic data 310 to generate one or more models 315 for analysis or production purposes.

In the exemplary embodiment, the secured environment 305 provides one or more parameters 330 about the desired synthetic data 310 to the API call. For example, a first parameter 330 can be the number of data records desired in the synthetic data 310. In one example, the records are financial transactions and/or payment transactions between a merchant and cardholder (or accountholder) that are processed over a payment network. For these records, the requested parameters 330 can include, but are not limited to, duration, date/time, industry, category, merchant country, number of issuing countries, number of merchants, transaction level, summary, number of cardholders, cardholder age, cardholder home location, and/or any other parameters desired based on the fields available in the real data 115. In at least one embodiment, the parameters 330 could be provided in a JSON format. The desired parameters 330 are provided to the synthetic data generator 205 and the synthetic data generator 205 generates data records according to those parameters that mimic the real data 115. The output synthetic data 310 includes the marginal and conditional distributions of the real data 115. In at least some embodiments, the output synthetic data 310 can be provided in a JSON format and can feature one or more parameters, such as, but not limited to, date/time, industry, category, transaction amount, transaction amount in merchant/issuer currency, merchant/issuer country, merchant issuer currency, and cardholder present code. In these embodiments, synthetic merchant names may be provided by the synthetic data generator 205 to distinguish the different merchants in the synthetic data 310.

In one example, the API 320 can request transaction level data from the synthetic data generator 205. In this example, a user can request a number of transactions, i.e., 50,000 transactions. The user can also request data for a specific merchant or location. This data can be further limited to provide data for a specific period of time, such as a year. The user can also request that the data showcases out of town vs. in town customers.

Since the synthetic data 310 is generated by the synthetic data generator 205, the synthetic data 310 does not provide insights at a low level for individual records or a low number of records.

In at least one embodiment, the synthetic data generator 205 can be trained using data for an entire country and be able to provide synthetic data 310 for one specific city or geographic region for that data. In some further embodiments, the synthetic data generator 205 can be trained to provide more precise data for the individual city by being trained using real data 115 from the specific city.

System architecture 300 protects the real data 115 from access by outside individuals and instead provides generated synthetic data 310. The generated synthetic data 310 can then be used by the outside individuals, e.g., the users of secured environment 305, where the generated synthetic data 310 includes similar characteristics to the real data 115, but prevents access to PII that might be stored, derived from, or otherwise hinted at in the real data 115.

In some embodiments, in order to provide meaningful insights while preserving individuals' privacy, the interface 320 can be designed around use cases. Some use cases include learning about transactions on a geographical level and the spending patterns of customers. The API 320 is configured to enable the user to input parameters 330 tailored to provide aggregated synthetic data 310 to aid in descriptive analytics. These generated synthetic data 310 can then be used as input for advanced analytics.

Some example questions that the API 320 can answer include: In a week, how many transactions are there in New York City? What is the distribution of the number of transactions and the amount spent? What is the variance of monthly spending amounts across various industries? Are there any industries with spending patterns of high variance, which can be an indication of seasonality patterns? What are the users' spending patterns across various industries? What other industries do high spenders in industry A also spend in?

In some embodiments, the design of the API 320 follows a RESTful (Representational State Transfer) style—each category of use case will have its own resource identifier which will be used by the end user to interact with the system 300. For instance, transactional level data and cardholder level data will each have its own resource identifier. The user first needs to identify himself and specify the scope of the data he wants, which includes both required and optional parameters 330, to the resource identifier. The synthetic data 310 will be included in the response.

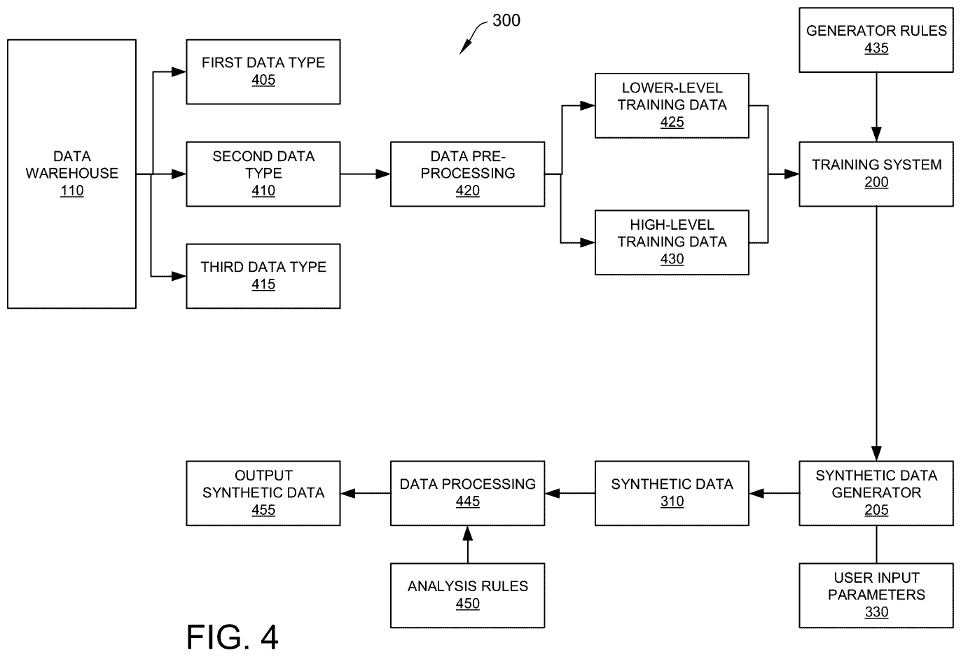

FIG. 4 illustrates a second system architecture 400 for secured cross-collaboration using the synthetic data generator 205 (shown in FIG. 2) and the system 300 (shown in FIG. 3). In the example embodiment, the data warehouse 110 is capable of providing multiple types of data, such as data types 405, 410, and 415. In a merchant or payment processing embodiment, the different types of data could include, for example, transaction data, merchant data, and industry data. The data warehouse 110 can provide any type of needed data based on the purpose of the system 100. These types of data 405, 410, and 415 can include, but are not limited to, weather data, education data, workflow data, production data, and/or any other type of desired data. The data is pre-processed 420. The pre-processing 420 can include, but is not limited to, cleaning up or removing incomplete records, ensuring the data is all formatted correctly, removing or hashing PII, or any other desired pre-processing to allow the data to be used as described herein.

In some embodiments, the data is divided into low-level training data 425 and high-level training data 430. In the merchant or payment processing embodiment, the low-level training data 425 could be cardholder-level data and the high-level training data 430 could be transaction-level data. The low- and high-training data 425 and 430 is input into the training system 200 to train the synthetic data generator 205. In some embodiments, the training system 200 also receives one or more generator rules 435 for training the synthetic data generator 205. In the exemplary embodiment, the training system 200 uses the training data 425 and 430 as real data 115 in training the synthetic data generator 205 as shown in FIG. 2. In some embodiments, the training system 200 uses both the low-level training data 425 and the high-level training data 430. In other embodiments, the training system 200 trains two synthetic data generators 205. One synthetic data generator 205 is trained with the low-level training data 425. The other synthetic data generator 205 is trained with the high-level training data 430. Then the appropriate synthetic data generator 205 is used to generate synthetic data 310 based on the user request.

In the exemplary embodiment, the synthetic data generator 205 receives one or more user input parameters 330 from the user via a user device 325 (shown in FIG. 3). In some embodiments, the user input parameters 330 are provided via the interface 320 (shown in FIG. 3), such as via an API call. The synthetic data generator 205 generates the synthetic data 310 in accordance with the user input parameters 330. Then the synthetic data 310 is provided for data processing 445. The data processing 445 may be governed by one or more analysis rules 450. The analysis rules 450 may include, but are not limited to, formatting rules, business rules, operations rules, and/or any other sets of rules that guide what information and how that information is presented to the user. After processing 445, the output synthetic data 455 is presented to the user, such as via the interface 320 (e.g., in a response to an API call) and/or the user device 325.

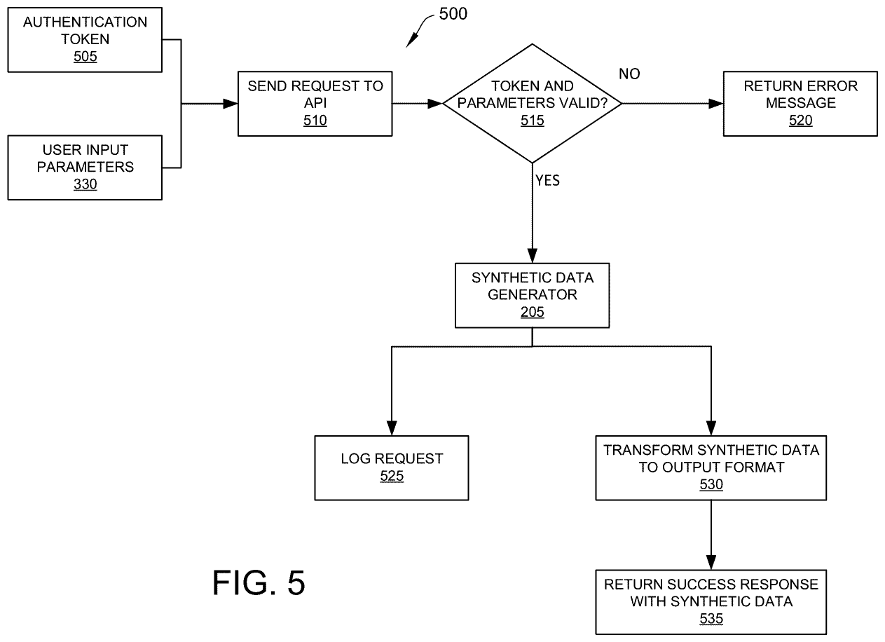

FIG. 5 illustrates an example data flow 500 for secured cross-collaboration using the synthetic data generator 205 (shown in FIG. 2) via interface 320 (shown in FIG. 3) implemented as an application programming interface (API). In at least one embodiment, the API is called by the secured environment 305 (shown in FIG. 3). In at least one embodiment, the API calls are responded to by the data generation computer device 105 (shown in FIG. 1).

In the exemplary embodiment, the secured environment 305 receives an authentication token 505 and user input parameters 330 from a user via a user device 325 (shown in FIG. 3) that desires to receive synthetic data 310 (shown in FIG. 3). The authentication token 505 may be any security token that contains authentication information to allow the user to access the synthetic data generator 205. The authentication token 505 may be authenticated by the secure environment 305 or other trusted system to confirm that the user is authorized to use the token. The user input parameters 330 describe the data that the user desires and includes one or more parameters of the desired data.

The secured environment 305 transmits an API request 510 to the interface 320. The API request 510 includes the authentication token 505 and the user input parameters 330. The user input parameters 330 can be provided in natural language and furthermore may include one or more desired parameters of the desired synthetic data 310, such as, but not limited to, age range, date range, and/or number of records. In some embodiments, the API request 510 includes a natural language request. The authentication token 505 and the user input parameters 330 are validated 515. In some embodiments, the validation 515 is performed by the secured environment 305. Additionally or alternatively, the validation 515 is performed by the interface 320. The user input parameters 330 may be determined invalid if they are outside of the ranges allowed by the synthetic data generator 205 or would otherwise cause issues with the synthetic data generator 205. If either the authentication token 505 or the user input parameters 330 are not valid, the secured environment 305 and/or the interface 320 return an error message 520.

If the authentication token 505 and the user input parameters 330 are validated, the interface 320 provides the user input parameters 330 to the synthetic data generator 205, which generates one or more sets of synthetic data 310 in accordance with the user input parameters 330. The interface 320 logs the request 525 and transforms 530 the synthetic data into an output format. In some embodiments, this includes performing data processing 445 (shown in FIG. 4) on the synthetic data 310. The interface 320 returns a successful API response 535. The secured environment 305 forwards the output synthetic data 310 to the user, such as via the user device 325.

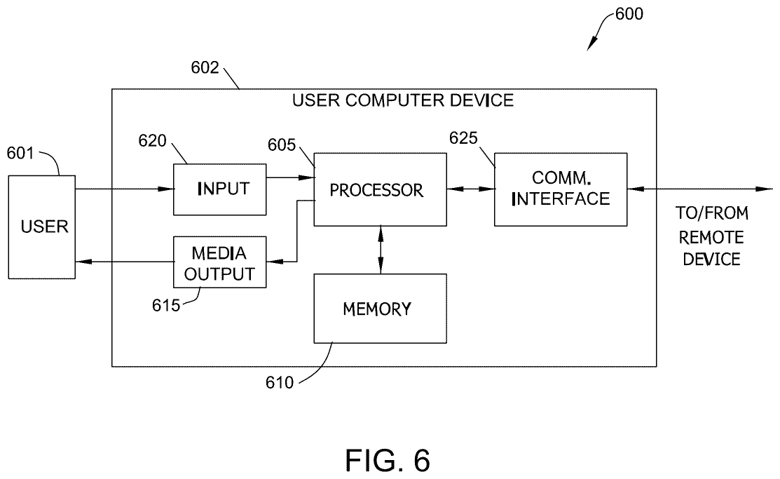

FIG. 6 illustrates an example configuration of a client system shown in FIG. 3, in accordance with one embodiment of the present disclosure. User computer device 602 is operated by a user 601. User computer device 602 may be used to implement, but is not limited to, a user device 325 (shown in FIG. 3). User computer device 602 includes a processor 605 for executing instructions. In some embodiments, executable instructions are stored in a memory area 610. Processor 605 may include one or more processing units (e.g., in a multi-core configuration). Memory area 610 is any device allowing information such as executable instructions and/or transaction data to be stored and retrieved. Memory area 610 may include one or more computer-readable media.

User computer device 602 also includes at least one media output component 615 for presenting information to user 601. Media output component 615 is any component capable of conveying information to user 601. In some embodiments, media output component 615 includes an output adapter (not shown) such as a video adapter and/or an audio adapter. An output adapter is operatively coupled to processor 605 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 615 is configured to present a graphical user interface (e.g., a web browser and/or a client application) to user 601. A graphical user interface may include, for example, analysis of synthetic data 310 (shown in FIG. 3). In some embodiments, user computer device 602 includes an input device 620 for receiving input from user 601. User 601 may use input device 620 to, without limitation, select and/or enter one or more user input parameters 440 (shown in FIG. 4). Input device 620 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 615 and input device 620.

User computer device 602 may also include a communication interface 625, communicatively coupled to a remote device such as data warehouse 110, data generation computer device 105, third-party data sources 120, production 135 (all shown in FIG. 1), and secured environment 305 (shown in FIG. 3). Communication interface 625 may include, for example, a wired or wireless network adapter and/or a wireless data transceiver for use with a mobile telecommunications network.

Stored in memory area 610 are, for example, computer-readable instructions for providing a user interface to user 601 via media output component 615 and, optionally, receiving and processing input from input device 620. The user interface may include, among other possibilities, a web browser and/or a client application. Web browsers enable users, such as user 601, to display and interact with media and other information typically embedded on a web page or a website provided by the data generation computer device 105 and/or the secured environment 305. A client application allows user 601 to interact with, for example, secured environment 305. For example, instructions may be stored by a cloud service and the output of the execution of the instructions sent to the media output component 615.

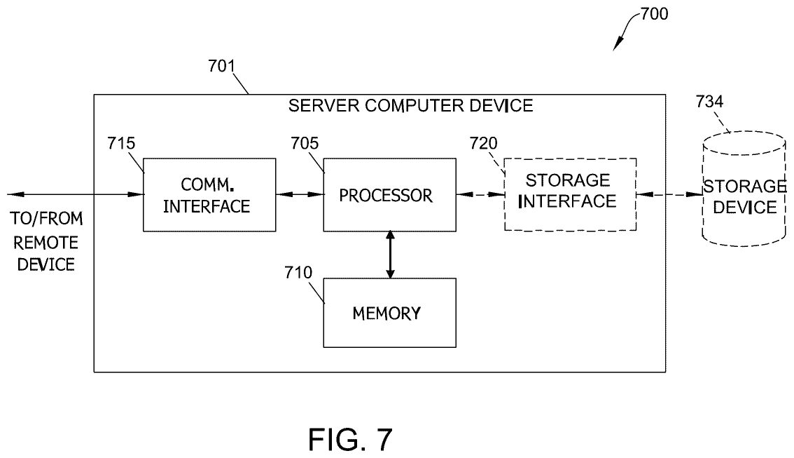

FIG. 7 illustrates an example configuration of a server system 700 that may be used to implement one or more computer devices shown in FIG. 3, in accordance with one embodiment of the present disclosure. Server computer device 701 may be used to implement, but is not limited to, data warehouse 110, data generation computer device 105, third-party data sources 120, production 135 (all shown in FIG. 1), and secured environment 305 (shown in FIG. 3). Server computer device 701 also includes a processor 705 for executing instructions. Instructions may be stored in a memory area 710. Processor 705 may include one or more processing units (e.g., in a multi-core configuration).

Processor 705 is operatively coupled to a communication interface 715 such that server computer device 701 is capable of communicating with a remote device such as another server computer device 701, data generation computer device 105, production 135, secured environment 305, or user device 325 (shown in FIG. 3). For example, communication interface 715 may receive requests from data generation computer device 105, secured environment 305, or via the Internet.

Processor 705 may also be operatively coupled to a storage device 734. Storage device 734 is any computer-operated hardware suitable for storing and/or retrieving data, such as, but not limited to, data associated with a database. In some embodiments, storage device 734 is integrated in server computer device 701. For example, server computer device 701 may include one or more hard disk drives as storage device 734. In other embodiments, storage device 734 is external to server computer device 701 and may be accessed by a plurality of server computer devices 701. For example, storage device 734 may include a storage area network (SAN), a network attached storage (NAS) system, and/or multiple storage units such as hard disks and/or solid state disks in a redundant array of inexpensive disks (RAID) configuration.

In some embodiments, processor 705 is operatively coupled to storage device 734 via a storage interface 720. Storage interface 720 is any component capable of providing processor 705 with access to storage device 734. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 734.

Processor 705 executes computer-executable instructions for implementing aspects of the disclosure. In some embodiments, processor 705 is transformed into a special purpose microprocessor by executing computer-executable instructions or by otherwise being programmed.

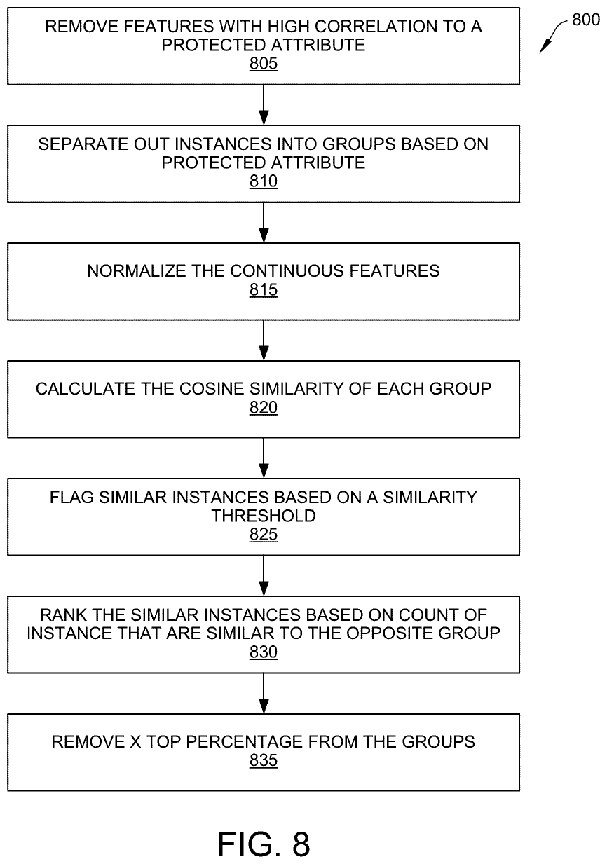

FIG. 8 illustrates an example process 800 for pre-processing data to remove bias in accordance with at least one embodiment of the present disclosure. In some embodiments, process 800 is performed during data pre-processing 420 (shown in FIG. 4). In the example embodiment, process 800 is performed by the data generation computer device 105 (shown in FIG. 1).

One side effect of artificial intelligence generated data and analysis is the possibility of introducing or keeping bias in the data. Different types of bias can be introduced in the data including, but not limited to, historical bias, aggregation bias, temporal bias, and social bias. Other types of bias can be introduced by the algorithms used, such as, but not limited to, popularity bias, ranking bias, evaluation bias, and emergent bias. The subsequent user interactions can also introduce behavioral bias, presentation bias, linking bias, and/or content production bias. In some embodiments, the goal is to generate synthetic data 310 (shown in FIG. 3) that is fair and bias-free. Having the training algorithm simply ignore or remove protected variables such as race, color, religion, gender, disability, or family status may, without more, be insufficient due to the existence of redundant encodings, which are methods of predicting protected attributes from other features. The data generator 205 uses noise data 210 (both shown in FIG. 2) to generate data, but in using real data 115 (shown in FIG. 1), the biases can inadvertently be trained into the generator 205 (shown in FIG. 2). Training a generator 205 to produce unbiased data can be very difficult and time consuming. Accordingly, applying bias mitigation techniques to the data pre-processing 420 can assist in generating fair and unbiased synthetic data 310 independent of the GAN architecture.

In at least one embodiment, this anti-bias data pre-processing 420 is performed using a % K removal technique. In process 800, the data generation computer device 105 removes 805 features with high correlation to a protected attribute. In at least one embodiment, the high correlation is greater than or equal to 0.7 correlation with the protected attribute. Furthermore, the data generation computer device 105 drops one of the features of pairs with correlation higher than 0.7.

The data generation computer device 105 separates 810 instances into groups based on protected attribute, whether privileged or unprivileged. In some embodiments, the data generation computer device 105 also separates 810 instances based on label (favorable or unfavorable). Then the data generation computer device 105 normalizes 815 the continuous features. In some further embodiments, the data generation computer device 105 hot encodes the categorical features.

The data generation computer device 105 calculates 820 the cosine similarity of each instance from the groups of unprivileged and unfavorable to each instance of the groups with privileged and favorable. Then the data generation computer device 105 flags 825 similar instances from both groups based on a similarity threshold. In some embodiments, the similarity threshold is 0.99.

The data generation computer device 105 ranks 830 the similar instances based on count of instance that are similar to the opposite group. In this case, the higher the count, the higher the rank. Then based on the ranks, the data generation computer device 105 removes 835 the top X percentage of instances from each of the unprivileged and privileged groups. These instances are biased as the output labels differ because of the protected attribute(s). This data pre-processing 420 improves both performance of the model as well as fairness of the model.

In further embodiments, the pre-processing technique creates fairer data that helps to understand the type of bias that exists in the datasets. If the bias arises from a lack of representation of a particular group, then that could indicate a sampling bias. If the bias arises because of human bias that is reflected in the labels, then that could indicate a prejudice-based bias. The data points of the synthetic data 310 along with the original data set 115 constitute an ideal dataset, as the labels no longer depend on protected attributes. Therefore, the model is trained on this overall dataset which represents an equitable world, thereby removing bias from the model.

In some embodiments, as discussed above, the design system is configured to implement machine learning, such that the neural network “learns” to analyze, organize, and/or process data without being explicitly programmed. Machine learning may be implemented through machine learning (ML) methods and algorithms. In an exemplary embodiment, a machine learning (ML) module is configured to implement ML methods and algorithms. In some embodiments, ML methods and algorithms are applied to data inputs and generate machine learning (ML) outputs. Data inputs may include but are not limited to analog and digital signals (e.g., sound, light, motion, natural phenomena, etc.). Data inputs may further include sensor data, image data, video data, transaction data, and telematics data. ML outputs may include but are not limited to digital signals (e.g., information data converted from natural phenomena). ML outputs may further include speech recognition, image or video recognition, medical diagnoses, statistical or financial models, autonomous vehicle decision-making models, robotics behavior modeling, fraud detection analysis, user input recommendations and personalization, game AI, skill acquisition, targeted marketing, big data visualization, weather forecasting, and/or information extracted about a computer device, a user, a home, a vehicle, or a party of a transaction. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, recurrent neural networks, Monte Carlo search trees, generative adversarial networks, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, ML methods and algorithms are directed toward supervised learning, which involves identifying patterns in existing data to make predictions about subsequently received data. Specifically, ML methods and algorithms directed toward supervised learning are “trained” through training data, which includes example inputs and associated example outputs. Based on the training data, the ML methods and algorithms may generate a predictive function which maps outputs to inputs and utilize the predictive function to generate ML outputs based on data inputs. The example inputs and example outputs of the training data may include any of the data inputs or ML outputs described above. For example, a ML module may receive training data comprising data associated with different trends and their corresponding classifications, generate a model which maps the trend data to the classification data, and recognize future trends and determine their corresponding categories.

In another embodiment, ML methods and algorithms are directed toward unsupervised learning, which involves finding meaningful relationships in unorganized data. Unlike supervised learning, unsupervised learning does not involve user-initiated training based on example inputs with associated outputs. Rather, in unsupervised learning, unlabeled data, which may be any combination of data inputs and/or ML outputs as described above, is organized according to a ML algorithm-determined relationship. In an exemplary embodiment, a ML module coupled to or in communication with the design system or integrated as a component of the design system receives unlabeled data comprising event data, financial data, social data, geographic data, cultural data, and/or political data, and the ML module employs an unsupervised learning method such as “clustering” to identify patterns and organize the unlabeled data into meaningful groups. The newly organized data may be used, for example, to extract further information about the potential classifications.

In yet another embodiment, ML methods and algorithms are directed toward reinforcement learning, which involves optimizing outputs based on feedback from a reward signal. Specifically, ML methods and algorithms directed toward reinforcement learning may receive a user-defined reward signal definition, receive a data input, utilize a decision-making model to generate a ML output based on the data input, receive a reward signal based on the reward signal definition and the ML output, and alter the decision-making model so as to receive a stronger reward signal for subsequently generated ML outputs. The reward signal definition may be based on any of the data inputs or ML outputs described above. In an exemplary embodiment, a ML module implements reinforcement learning in a user recommendation application. The ML module may utilize a decision-making model to generate a ranked list of options based on user information received from the user and may further receive selection data based on a user selection of one of the ranked options. A reward signal may be generated based on comparing the selection data to the ranking of the selected option. The ML module may update the decision-making model such that subsequently generated rankings more accurately predict optimal constraints.

The computer-implemented methods and processes described herein may include additional, fewer, or alternate actions, including those discussed elsewhere herein. The present systems and methods may be implemented using one or more local or remote processors, transceivers, and/or sensors (such as processors, transceivers, and/or sensors mounted on vehicles, stations, nodes, or mobile devices, or associated with smart infrastructures and/or remote servers), and/or through implementation of computer-executable instructions stored on non-transitory computer-readable media or medium. Unless described herein to the contrary, the various steps of the several processes may be performed in a different order, or simultaneously in some instances.

Additionally, the computer systems discussed herein may include additional, fewer, or alternative elements and respective functionalities, including those discussed elsewhere herein, which themselves may include or be implemented according to computer-executable instructions stored on non-transitory computer-readable media or medium.

In the exemplary embodiment, a processing element may be instructed to execute one or more of the processes and subprocesses described above by providing the processing element with computer-executable instructions to perform such steps/sub-steps, and store collected data (e.g., trust stores, authentication information, etc.) in a memory or storage associated therewith. This stored information may be used by the respective processing elements to make the determinations necessary to perform other relevant processing steps, as described above.

The aspects described herein may be implemented as part of one or more computer components, such as a client device, system, and/or components thereof, for example. Furthermore, one or more of the aspects described herein may be implemented as part of a computer network architecture and/or a cognitive computing architecture that facilitates generation of synthetic data for providing to various other devices and/or components. Thus, the aspects described herein address and solve issues of a technical nature that are necessarily rooted in computer technology.

Furthermore, the embodiments described herein improve upon existing technologies, and improve the functionality of computers, by more reliably protecting the integrity and efficiency of computer networks and the devices on those networks at the server-side, and by further enabling the easier and more efficient generation of bias-free data at the server-side and the client-side. The present embodiments therefore improve the speed, efficiency, and reliability in which such determinations and processor analyses may be performed. Due to these improvements, the aspects described herein address computer-related issues that significantly improve the efficiency of generating synthetic bias-free data.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A data generation system for secure synthetic data generation comprising:
at least one processor; and
a memory device in operable communication with the at least one processor, the memory device including computer-executable instructions stored therein, which, when executed by the processor, cause the at least one processor to:
receive a plurality of historical data including one or more trends;
train a data generator with the plurality of historical data and a plurality of noise data to generate data to simulate the one or more trends;
receive one or more user input parameters;
execute the data generator with the one or more user input parameters to generate a plurality of synthetic data, wherein the plurality of synthetic data includes the one or more trends; and
output the plurality of synthetic data to a user.

2. The system of claim 1, wherein the data generator is trained with a plurality of types of data.

3. The system of claim 2, wherein the plurality of types of data are pre-processed before training the data generator.

4. The system of claim 1, wherein the plurality of historical data includes a plurality of individual data records.

5. The system of claim 4, wherein plurality of synthetic data is randomized by the plurality of noise data so that the plurality of synthetic data cannot be traced back to the individual data records of the plurality of individual data records.

6. The system of claim 1, wherein the at least one processor is further programmed to:
receive one or more analysis rules; and
apply the one or more analysis rules to the plurality of synthetic data prior to outputting the plurality of synthetic data.

7. The system of claim 1, wherein the data generator is trained with a generative adversarial network.

8. The system of claim 1, wherein the one or more user input parameters include one or more parameters of the desired plurality of synthetic data.

9. The system of claim 1, wherein the at least one processor is further programmed to:
receive a request for the plurality of synthetic data through an application programming interface (API); and
output the plurality of synthetic data through the API.

10. The system of claim 1, wherein the at least one processor is further programmed to, prior to training the data generator, pre-process the plurality of historical data to remove one or more types of bias.

11. A method for secure synthetic data generation, wherein the method is implemented by a computer device comprising at least one processor in communication with at least one memory device, and wherein the method comprises:
receiving a plurality of historical data including one or more trends;
training a data generator with the plurality of historical data and a plurality of noise data to generate data to simulate the one or more trends;
receiving one or more user input parameters;
executing the data generator with the one or more user input parameters to generate a plurality of synthetic data, wherein the plurality of synthetic data includes the one or more trends; and
outputting the plurality of synthetic data to a user.

12. The method of claim 11 further comprising training the data generator with a plurality of types of data.

13. The method of claim 12 further comprising pre-processing the plurality of types of data before training the data generator.

14. The method of claim 11, wherein the plurality of historical data includes a plurality of individual data records.

15. The method of claim 14 further comprising randomizing the plurality of synthetic data by the plurality of noise data so that the plurality of synthetic data cannot be traced back to the individual data records of the plurality of individual data records.

16. The method of claim 11 further comprising:
receiving one or more analysis rules; and
applying the one or more analysis rules to the plurality of synthetic data prior to outputting the plurality of synthetic data.

17. The method of claim 11 further comprising training the data generator with a generative adversarial network.

18. The method of claim 11, wherein the one or more user input parameters include one or more parameters of the desired plurality of synthetic data.

19. The method of claim 11 further comprising:
receiving a request for the plurality of synthetic data through an application programming interface (API); and
outputting the plurality of synthetic data through the API.

20. The method of claim 11 further comprising, prior to training the data generator, pre-processing the plurality of historical data to remove one or more types of bias.
